(19) United States
(12) Patent Application Publication
(10) Pub. No.: US 2018/0260404 A1
(43) Pub. Date: Sep. 13, 2018

(54) GLOBAL ACCESS TO REMOVABLE STORAGE MEDIA ITEMS

(71) Applicant: Quantum Corporation, San Jose, CA (US)

(72) Inventors: Jonathan Otis, Seattle, WA (US); George Saliba, Boulder, CO (US)

(21) Appl. No.: 15/453,043

(22) Filed: Mar. 8, 2017

(51) Int. Cl. G06F 17/30

(52) U.S. Cl. CPC G06F 17/30091; G06F 17/30879; G06F 17/3087

(57) ABSTRACT

Embodiments disclosed herein provide systems, methods, and computer readable media to provide access to items of removable storage media identified using globally unique identifiers. In a particular embodiment, a method provides assigning a first globally unique identifier to a first item of removable storage media. The method further provides receiving a first request to access the first item. The first request includes the first globally unique identifier. In response to the first request, the method provides using the first globally unique identifier to determine a location of the first item from a plurality of removable storage media items and providing access to the first item.

### TECHNICAL FIELD

Aspects of the disclosure are related to the access of data on removable storage media and, in particular, to easily accessing that data from anywhere.

### TECHNICAL BACKGROUND

Removable media types, such as magnetic tape cartridges or optical discs, are oftentimes packaged into systems that allow for many items of removable media to be stored and placed into an access device when needed. An automated (e.g., robotic) magnetic tape library is one example of such a system. Given the need for placement of removable media into an access device, which greatly increases the amount of time required to access data thereon, such removable media storage systems are typically used for more long-term storage of data. For instance, data backup systems may use removable storage media to store data backups. That data would only need to be accessed should it be needed for data restoration at a later time, which may never occur.

Typically, data will be stored to removable storage media in a particular storage system where a host system manages the data stored to the removable storage media therein. Thus, when data is received by the host system, the host system selects one or more items of removable storage media onto which the received data should be stored. Should that data ever need to be retrieved, the host system maintains information about where that data was stored (i.e., which media item(s) the data was stored on and where on those items the data is located). The data must therefore always be requested from that specific host system. Should multiple such storage systems, and respective hosts, be available to store the data, a particular storage system would need to be selected for storing the data and the data would only be accessible in the future from that system.

### OVERVIEW

Embodiments disclosed herein provide systems, methods, and computer readable media to provide access to items of removable storage media identified using globally unique identifiers. In a particular embodiment, a method provides assigning a first globally unique identifier to a first item of removable storage media. The method further provides receiving a first request to access the first item. The first request includes the first globally unique identifier. In response to the first request, the method provides using the first globally unique identifier to determine a location of the first item from a plurality of removable storage media items and providing access to the first item.

In some embodiments, the method provides writing first data to the first item, wherein assigning the first globally unique identifier first item comprises assigning the first globally unique identifier to the first data.

In some embodiments, the first globally unique identifier comprises information describing the location of the first item and a location of the first data on the first item.

In some embodiments, a lookup table indicates the location of the first item and a location of the first data on the first item in association with the first globally unique identifier, and wherein using the first globally unique identifier to locate the first item comprises referencing the lookup table to identify the location of the first item and the location of the first data.

In some embodiments, the method provides receiving the first data over a communication network from a first user and providing the first globally unique identifier to the first user over the communication network. In these embodiments, receiving the first request comprises receiving the first request from the first user.

In some embodiments, the method further provides associating the first globally unique identifier with the first user and determining that the first request is associated with the first user. In these embodiments, providing access to the first item occurs in response to determining that the first request is associated with the first user.

In some embodiments, the method further provides designating a plurality of globally unique identifiers to an entity associated with the first user. In these embodiments, assigning the first globally unique identifier comprises selecting the first globally unique identifier from the plurality of globally unique identifiers.

In some embodiments, the method further provides designating a plurality of globally unique identifiers to a geographic region that includes the location of the first item. In these embodiments assigning the first globally unique identifier comprises selecting the first globally unique identifier from the plurality of globally unique identifiers.

In some embodiments, the method provides generating the first globally unique identifier based on the first item.

In some embodiments, assigning the first globally unique identifier comprises optically reading at least a component of the first globally unique identifier from a barcode on the first item.

In some embodiments, assigning the first globally unique identifier comprises reading at least a component of the first globally unique identifier from information stored on the first item.

In some embodiments, the first item comprises one of a magnetic tape cartridge, a solid-state memory drive in a removable enclosure, or a hard disk drive in a removable enclosure.

In some embodiments, the first globally unique identifier comprises a uniform resource locator (URL).

In another embodiment, a system is provided having one or more computer readable storage media and a processing system operatively coupled with the one or more computer readable storage media. Program instructions stored on the one or more computer readable storage media, when read and executed by the processing system, direct the processing system to assign a first globally unique identifier to a first item of removable storage media and receive a first request to access the first item. The first request includes the first globally unique identifier. In response to the first request, the program instructions direct the processing system to use the first globally unique identifier to determine a location of the first item from a plurality of removable storage media items and provide access to the first item.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a data storage environment for accessing removable storage media using globally unique identifiers.

FIG. 2 illustrates a method of operating the data storage environment to access removable storage media using globally unique identifiers.

FIG. 3 illustrates another data storage environment for accessing removable storage media using globally unique identifiers.

FIG. 4 illustrates an example scenario for operating the other data storage environment to access removable storage media using globally unique identifiers.

FIG. 5 illustrates another example scenario for operating the other data storage environment to access removable storage media using globally unique identifiers.

FIG. 6 illustrates a method of operating the other data storage environment to access removable storage media using globally unique identifiers.

FIG. 7 illustrates another method of operating the other data storage environment to access removable storage media using globally unique identifiers.

FIG. 8 illustrates yet another method of operating the other data storage environment to access removable storage media using globally unique identifiers.

FIG. 9 illustrates a computing architecture for accessing removable storage media using globally unique identifiers.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

While the technology provided below can be used with respect to a single removable media storage system, the most benefit can be seen with respect to multiple removable media storage systems. The multiple systems may even be located at different geographic locations. A globally unique identifier is used for each set of data that is stored to one of the removable media storage systems. The globally unique identifier is globally unique because it will not occur more than once to identify data sets in any of the removable media storage systems. Thus, as will be explained in more detail below, a data set identified by a particular globally unique identifier can be stored onto, and subsequently retrieved from, one of the multiple removable media storage systems irrespective of which particular removable media storage system is used to store the data set.

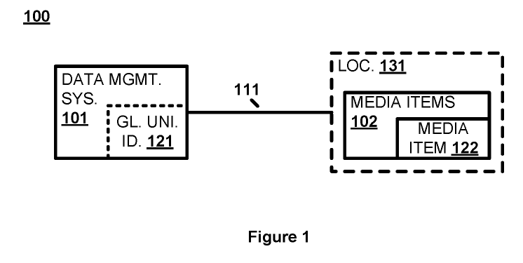

FIG. 1 illustrates data storage environment 100 for accessing removable storage media using globally unique identifiers. Data storage environment 100 includes data management system 101 and removable storage media items 102. Removable storage media items 102 are at media location 131. It is possible, but not necessary, that data management system 101 may also be located at media location 131. Data management system 101 and media location 131 communicate over communication link 111. It should be understood that data management system 101 communicating with media location 131 comprises data management system 101 communicating with one or more computing systems at media location 131 that facilitate the access of data stored on removable storage media items 102.

In operation, media location 131 is one of possibly many locations where data is stored on removable storage media items. Data management system 101 may interact with those additional media locations in the same manner as data management system 101 does with media location 131, as described below. Alternatively, data management system 101 may cooperate with other data management systems that perform in the same manner as data management system 101 does with media location 131 (in some cases, all of the multiple data management systems may be considered data management system 101 in the singular). Regardless of the number of media locations, data management system 101 facilitates the use of globally unique identifiers to identify data stored to removable storage media items. Once a particular data set is stored and given a globally unique identifier by data management system 101, the data set can be easily located by data management system 101 when provided with that globally unique identifier.

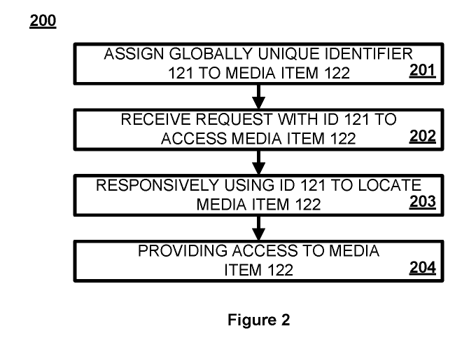

FIG. 2 illustrates method 200 of operating data storage environment 100 to access removable storage media using globally unique identifiers. Method 200 provides data management system 101 assigning globally unique identifier 121 to removable storage media item 122 (201). In the most basic sense, the globally unique identifier need only be an identifier that is unique from any other globally unique identifier used with respect to data storage environment 100, including those that may be used with respect to removable storage media items at other media locations. As such, globally unique identifier 121 may be any unique string of one or more numbers, letters, symbols, binary values, or other type of characters—including combinations thereof. However, some examples allow for more deterministic algorithms and/or combinations to be used when determining globally unique identifier 121.

In some cases, globally unique identifier 121 may be assigned to particular data stored on removable storage media item 122 rather than removable storage media item 122 as a whole. In those cases, globally unique identifier 121 would have to be assigned after the data stored, or to be stored, on removable storage media item 122 has been identified. Globally unique identifier 121 may be generated based on a removable storage media item 122, based on the location of associated data within removable storage media item 122, based on removable storage media item 122's presence at media location 131, or based on some other factor. In some cases, at least a component of globally unique identifier 121 may be retrieved from removable storage media item 122. For example, removable storage media item 122 may be given a unique identifier before being added to removable storage media items 102 (e.g., may be given the unique identifier at the time of manufacture).

At a time after data management system 101 has associated globally unique identifier 121 with removable storage media item 122, method 200 provides data management system 101 receiving a request to access removable storage media item 122 (202). The access request includes globally unique identifier 121 to indicate removable storage media item 122. The access request may be to read data from or write data to removable storage media item 122.

In response to the access request, method 200 provides data management system 101 using globally unique identifier 121 to determine a location of removable storage media item 122 (203). Not only is media location 131 identified from among other media locations that may exist but, also, removable storage media item 122 is identified from amongst removable storage media items 102. Depending on how globally unique identifier 121 is generated, globally unique identifier 121 may itself indicate the location of removable storage media item 122 (e.g., a location identifier explicitly included in globally unique identifier 121) or data management system 101 may maintain a data structure that associates globally unique identifier 121 with the location of removable storage media item 122. In some cases, data management system 101 may rely on systems at media location 131 to locate removable storage media item 122. For example, data management system 101 may determine that removable storage media item 122 is located at media location 131 and then relies on a management system within media location 131 to know where in media location 131 removable storage media item 122 is located (e.g., in what media storage slot removable storage media item 122 is stored).

Once located, method 200 includes data management system 101 providing access to removable storage media item 122 (204). Access to removable storage media item 122 allows whatever system issued the access request to data management system 101 to access removable storage media item 122. Data written to or read from removable storage media item 122 as part of the access may pass through data management system 101 or may be exchanged with media location 131 without data management system 101 as a middle man (e.g., data management system 101 may provide the access requesting system with the necessary information of media location 131 to allow the access requesting system to communicate with media location 131 directly.

Due to the nature of removable storage media items, systems at media location 131 may have to reposition removable storage media item 122 into an access position. For example, if removable storage media item 122 is an optical disk or a magnetic tape cartridge, systems at media location 131 (e.g., robot elements, controllers, etc.) may need to move removable storage media item 122 into a drive for accessing that type of media. The systems at media location 131 may in some cases need to move another one of removable storage media items 102 from the access position to make room for removable storage media item 122 to be placed there.

Advantageously, a system requesting access to removable storage media item 122 need only know removable storage media item 122's globally unique identifier. The access requesting system does not need to know that removable storage media item 122 is located at media location 131 to issue an access request to media location 131. Rather, the system requesting access relies on data management system 101 to determine the location of removable storage media item 122 and provide access to removable storage media item 122 regardless of where removable storage media item 122 is located.

Referring back to FIG. 1, data management system 101 comprises a computer processor system and a communication interface. data management system 101 may also include other components such as a user interface, router, server, data storage system, and power supply. Data management system 101 may reside in a single device or may be distributed across multiple devices. Data management system 101 may comprise a personal computer, application server, or some other computing apparatus—including combinations thereof.

Media location 131 includes one or more computing systems for accessing removable storage media items 102. Each computing system includes a computer processor system and a communication interface. Media location 131 may further include one or more media changer devices controlled by the one or more computing systems to move removable storage media items 102 to various positions at media location 131 (e.g., between media storage positions and media access positions, such as media access drives). Each media changer device may include motors, belts, gears, or some other type of moving component. In one example, a media changer device may comprise one or more robotic arm apparatuses for grabbing and repositioning removable media items.

Removable storage media items 102 may comprise any type of removable storage media. Removable storage media items 102 may comprise magnetic tape, optical disk, magnetic disk, flash memory, or some other type of removable memory. In general, Removable storage media items comprises any type of computer readable medium that is designed to be readily removed and not always be coupled to a computing system capable of reading that media. For example, magnetic tape cartridges are designed for access by a computing system when inserted into a magnetic tape drive but can be removed for portability or to free up the drive for access to other magnetic tape cartridges. In some cases, media types may be considered removable depending on the type of enclosure used. For instance, a hard disk drive may be placed in an enclosure allowing for easy insertion and removal from a system rather than being more permanently installed. In no examples are removable storage media items 102 a mere propagated signal.

Communication link 111 uses metal, glass, air, space, or some other material as the transport media. Communication link 111 could use various communication protocols, such as Time Division Multiplex (TDM), Internet Protocol (IP), Ethernet, RS-232, Controller Area Network (CAN), Small Computer System Interface (SCSI), Fiber Channel, communication signaling, Code Division Multiple Access (CDMA), Evolution Data Only (EVDO), Worldwide Interoperability for Microwave Access (WIMAX), Global System for Mobile Communication (GSM), Long Term Evolution (LTE), Wireless Fidelity (WIFI), High Speed Packet Access (HSPA), or some other communication format—including combinations thereof. Communication link 111 could be a direct link or may include intermediate networks, systems, or devices.

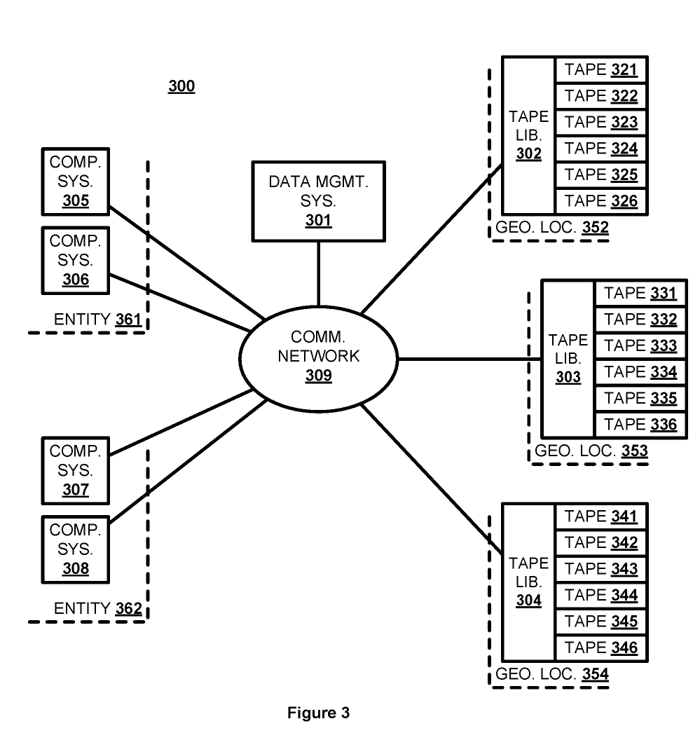

FIG. 3 illustrates data storage environment 300 for accessing removable storage media using globally unique identifiers. Data storage environment 300 includes data management system 301, tape libraries 302-304, computing systems 305-308, and communication network 309. Elements data management system 301-308 exchange communications over communication links with communication network 309. Communication network 309 may comprise any number of network elements, such as routers, switches, access points, etc., and may include one or more local area networks (LANs) and wide area networks (WANs), such as the Internet. In some cases, portions of communication network 309, such as a LAN, may be co-located with other of elements 301-308.

In operation, data management system 301 facilitates access to magnetic tape cartridges 321-326, 331-336, and 341-346 which are held in tape library 302, tape library 303, and tape library 304, respectively. Each of tape libraries 302-304 therefore include one or more magnetic tape drives, magnetic tape cartridge movement devices (e.g., robotic arms), and computing systems necessary to access magnetic tape cartridges and communicate their data over communication network 309. Each of tape libraries 302-304 is located at a respective geographic location 352-354. The differing geographic locations are used in this example to illustrate that magnetic tape cartridge access provided by data management system 301 can be location independent, although, in other examples, data management system 301 may be configured to take the geographic location into account when determining where data should be stored (e.g., certain data may be prohibited from being stored in certain geographic locations or in certain magnetic tape libraries).

It should be understood that, while data management system 301 acts as a single point of contact for accessing data in tape libraries 302-304 in data storage environment 300, data management system 301 may be distributed across multiple devices and locations. For example, an instance of data management system 301 may be operating at each of geographic locations 352-354 in conjunction with each of tape libraries 302-304. In these examples, the globally unique identifier used to access data, as described below, may indicate to which instance of data management system 301 data access requests should be sent. Alternatively, a data access request may be sent to any instance of data management system 301, which may transfer the request to a different instance if necessary.

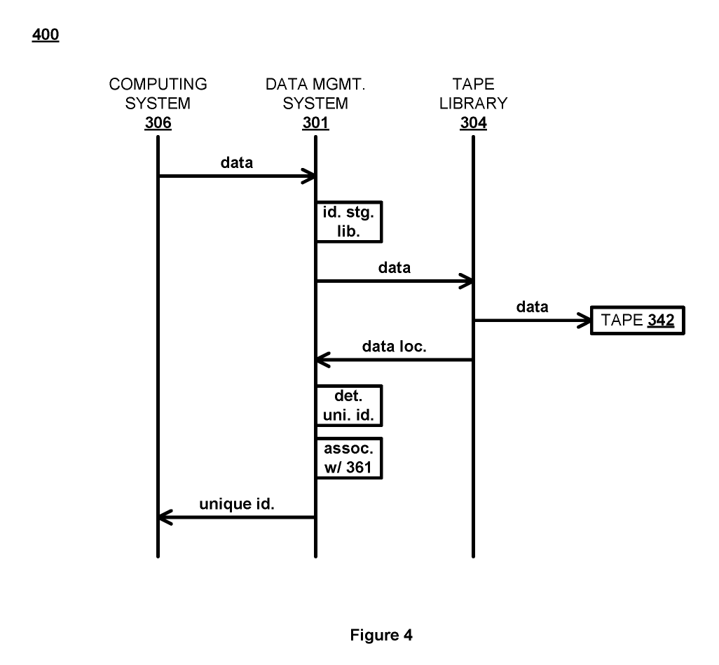

FIG. 4 illustrates example scenario 400 for operating data storage environment 300 to access removable storage media using globally unique identifiers. In scenario 400, computing system 306 transfers data to data management system 301 for storage on one or more magnetic tape cartridges. The data of this example is stored on only one magnetic tape cartridge for simplicity. Computing system 306 may be a computing system that is configured to archive or backup data on behalf of entity 361 but could be any type of computing system capable of transferring data over communication network 309, including a personal computer workstation. In some examples, rather than passing the actual data to data management system 301, computing system 306 may provide data management system 301 with parameters of the data, such as the amount of data, so that data management system 301 can determine where the data should be stored.

As alluded to above, upon receiving the data, data management system 301 identifies a tape library into which the data should be stored. In some cases, data management system 301 may even determine a specific magnetic tape cartridge onto which the data should be stored while, in other cases, the data management system 301 may rely on the selected tape library to determine the specific magnetic tape cartridge from the magnetic tape cartridges stored therein. Tape library 304 is selected by data management system 301 in this example to store the data from computing system 306. Any number of factors may have led to the selection of tape library 304 including random selection, geographic location preference, load balancing, affinity with other data associated with computing system 306 or entity 361, data location requirements (e.g., entity 361 requires their data be stored to tape library 304), or any other aspect that may influence the selection of one tape library over another.

Once tape library 304 is selected, the data is transferred to tape library 304 for storage. Scenario 400 specifically shows the data being transferred by data management system 301 to tape library 304 but, in examples where the data itself is not sent to data management system 301, data management system 301 may notify computing system 306 that the data should be transferred to tape library 304 and computing system 306 will transfer the data to tape library 304 accordingly. Upon receiving the data, tape library 304 writes the data to magnetic tape cartridge 342 and transfers information indicating the location of the data back to data management system 301. For instance, the information may indicate a start point, a stop point, and/or a size of the data, if data management system 301 did not know the size of the data already.

Data management system 301 then determines a globally unique identifier for the data. The globally unique identifier may be formatted such that data management system 301 can determine the location of the data from the globally unique identifier itself (e.g., have the data's location explicitly encoded therein) or may be formatted such that a data management system 301 maintains the data's location information in association with the globally unique identifier. Regardless, of how the data's location can be found using the globally unique identifier, the globally unique identifier must be unique from any other data that is or will be accessible by data management system 301. For instance, even though entity 361 is separate from entity 362, the globally unique identifiers will still be unique across both entities, or any other entity that uses data management system 301.

In addition to generating the globally unique identifier, data management system 301 associates the globally unique identifier with entity 361. The association prevents unauthorized access of the data from parties outside of entity 361. Entity 361, and entity 362, may each be a person(s), a business, governmental organization, school, or some other type of organization. In some cases, only certain systems or users within entity 361 are allowed to access the data. Thus, the association of the data may be ensured via password protection, allowed or disallowed network addresses, or any other manner in which access requests using the globally unique identifier may be limited to those associated with and/or authorized by entity 361. In some examples, computing system 306 may be provided with the software tools necessary to generate globally unique identifiers and may, therefore, generate the globally unique identifier itself in a manner similar to that used by data management system 301.

The globally unique identifier is then transferred to computing system 306 so that computing system 306, or any other system that would satisfy the association with entity 361, can use the globally unique identifier at a later time to access the data. In most cases, computing system 306, computing system 305, or some other computing system entity 361, stores many more data sets magnetic tape cartridges using data management system 301 and each of those other data sets would receive a globally unique identifier like the one described above. Entity 361 (e.g., via computing system 306) may therefore maintain a catalog of all the globally unique identifiers that represent each data set in case any of those data sets are to be accessed.

Effectively, scenario 400 allows computing system 306 to provide data management system 301 with data for storage and is provided with a globally unique identifier should that data ever need to be accessed in the future. Aside from the globally unique identifier, computing system 306 or any other authorized system need not know any other information about where the data is located. That is, there is no need for any system accessing the data through data management system 301 to know that the data was stored on magnetic tape cartridge 342 or even that the data was stored in tape library 304. Data management system 301 will simply use the globally unique identifier to find and access the data, as explained in more detail below. Moreover, the globally unique identifiers allow for data management system 301 to intermingle data stored on behalf of both entity 361 and entity 362 (or any other entity) across magnetic tape cartridges in each of tape libraries 302-304. Unless mandated by the entities themselves, or for some other artificial reason, there is no need to segregate data from the various entities.

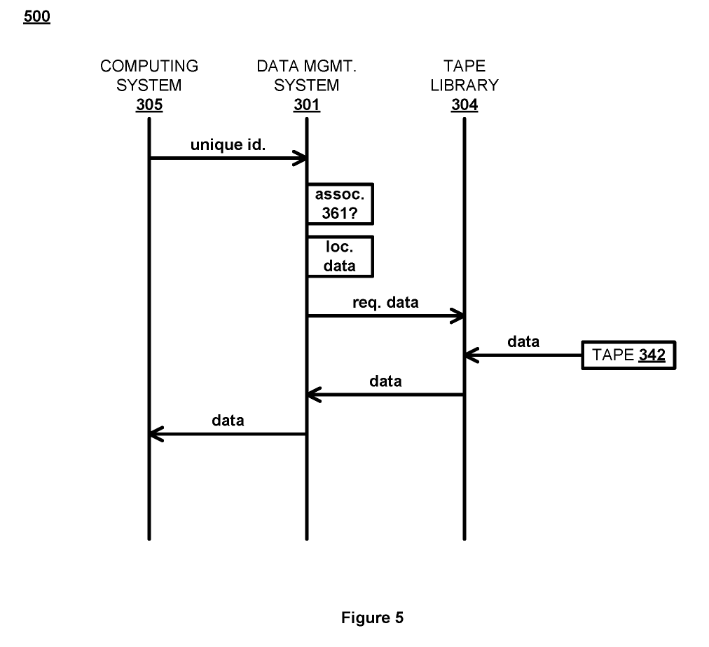

FIG. 5 illustrates another example scenario 500 for operating data storage environment 300 to access removable storage media using globally unique identifiers. In this example, it is computing system 305 that is attempting to access the data that was stored in scenario 400 from computing system 306. Computing system 305 may have received the globally unique identifier for the data from computing system 306, from user input, from some other system of entity 361, or from some other source. Regardless of how computing system 305 received the globally unique identifier, computing system 305 transfers the globally unique identifier to data management system 301 so that data management system 301 can provide access to the data. The globally unique identifier may be included in a request to access the data.

Upon receiving the globally unique identifier, data management system 301 determines whether computing system 305 is associated with entity 361 since the globally unique identifier is associated with entity 361. Data management system 301 may recognize that computing system 305 is associated with entity 361 based on an IP address of computing system 305. In some cases, computing system 305 may need to provide data management system 301 with authentication information (e.g., username, password, or otherwise) to show that computing system 305 is properly associated with entity 361.

In this example, data management system 301 determines that computing system 305 is associated with entity 361 and proceeds to locate the data requested using the globally unique identifier. As noted above, the globally unique identifier may explicitly indicate the location of the data so that data management system 301 simply needs to decode the globally unique identifier, if necessary, to obtain the location of the requested data. Alternatively, data management system 301 may reference a table, or other type of data structure, that includes the location of the data in association with the globally unique identifier.

Data management system 301 determines that the data is located in tape library 304 on magnetic tape cartridge 342 and where on magnetic tape cartridge 342 the data is located. Accordingly, data management system 301 requests the data from tape library 304 by indicating magnetic tape cartridge 342 to tape library 304 and the location of the data on magnetic tape cartridge 342. Tape library 304 then performed any action necessary to read the data from magnetic tape cartridge 342, such as moving magnetic tape cartridge 342 into a drive that can read the data from magnetic tape cartridge 342. Upon reading the data, the data is transferred by tape library 304 to data management system 301 and then from data management system 301 to computing system 305 to fulfill computing system 305's request. In some cases, tape library 304 may be provided by data management system 301 with the information necessary for tape library 304 to transfer the data to computing system 305 without the data passing through data management system 301.

In scenario 500 above, computing system 305 only needed the globally unique identifier to retrieve the requested data. Computing system 305 did not need to know from which of tape libraries 302-304 the data needed to be requested nor from which tape the data needed to be read.

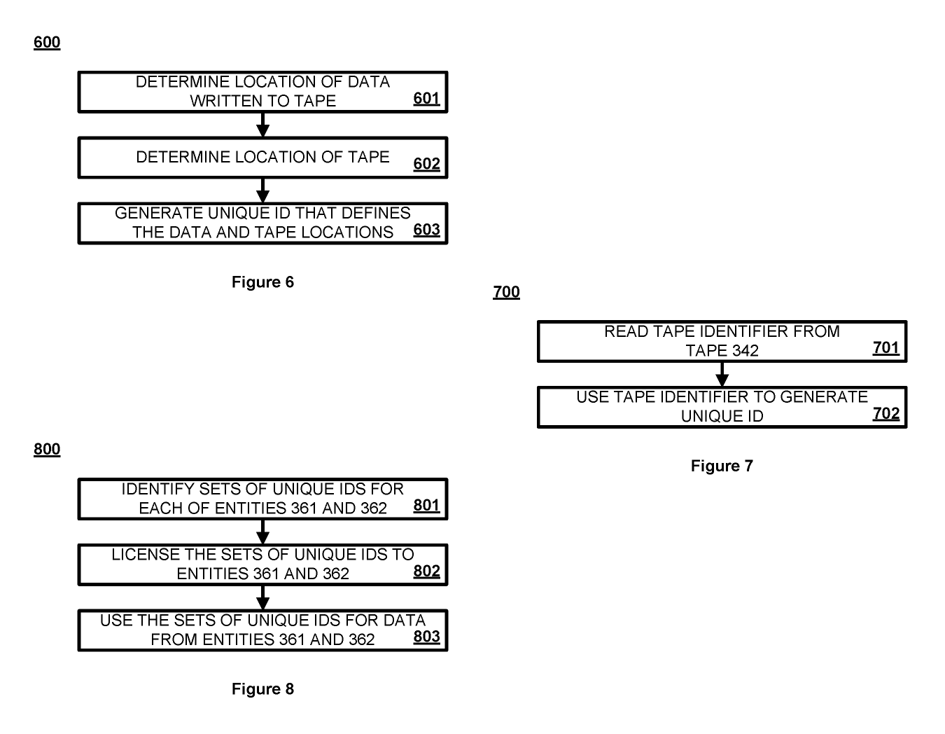

FIG. 6 illustrates method 600 of operating data storage environment 300 to generate a globally unique identifier. Specifically, method 600 may be used by data management system 301 in scenario 400 to generate the globally unique identifier. Method 600 provides data management system 301 determining the location of the data written to magnetic tape cartridge 342 as it sits on magnetic tape cartridge 342 (601). For instance, the location may be defined by a start point and a stop point of the data, the latter of which may be inferred from the size of the data written to magnetic tape cartridge 342. Additionally, method 600 provides data management system 301 determining a location of magnetic tape cartridge 342 (602). The location of magnetic tape cartridge 342 may simply be that magnetic tape cartridge 342 is in tape library 304 or may indicate a particular position of magnetic tape cartridge 342 within tape library 304.

From the two locations determined above, method 600 provides data management system 301 generating a globally unique identifier for the data that explicitly defines the two locations (602). In a basic example, the globally unique identifier that is generated may be “magnetic tape cartridge 342, tape library 304, start position X, size Y.” When used later on, that globally unique identifier would be enough for data management system 301 to locate the data and have tape library 304 read the data from magnetic tape cartridge 342. In some examples, that same information may be encoded in some manner that data management system 301 can still readily interpret. For example, tape libraries 302-304 may be represented by a single digit 1, 2, and 3, respectively. More complex algorithms may also be used to encode the globally unique identifier.

In some examples, the globally unique identifier may be formatted as a uniform resource locator (URL). For instance, data management system 301 may be represented by a hostname component of the URL followed by the data location as a file location of the URL. Using an example similar to the basic example above, the URL may comprise “www.datamanagementsystem301.com/magnetic_tape_cartridge_342/tape_library_304/X/Y.”Alternatively, the data location may be encoded in a similar manner to that already mentioned above.

While the example of scenario 600 describes a globally unique identifier that includes a tape identifier, tape library identifier, and indicators of data position on the tape, the globally unique identifier in some examples may not contain as much information. For instance, data management system 301 may be configured such that only a globally unique identifier for the tape is needed, such as the unique tape identifier described in method 700 below. In such examples, the globally unique identifier may be provided to data management system 301 along with a file name of the data to be accessed. Data management system 301 responsively finds the tape having that globally unique identifier and the file name is used to find the data on that tape. In some cases, the tape may include an index that indicates where data for each filename is stored thereon, which is written once the location of the data stored on the tape is known.

Thus, when storing the data in the context of scenario 400, computing system 306 need only provide data management system 301 with the data and the data's filename. Data management system 301 would responsively provide computing system 306 with the globally unique identifier of magnetic tape cartridge 342 for computing system 306 to associate with the data. Likewise, to access that data in the context of scenario 500, computing system 306 provides data management system 301 with the globally unique identifier and the data's filename. Data management system 301 would use the globally unique identifier to recognize that the data is stored on magnetic tape cartridge 342 and then filename is used to locate the data on magnetic tape cartridge 342 using the index method noted above or in some other manner. One specific manner for organizing and locating data on a magnetic tape cartridge (or other type of removable storage media) is disclosed in U.S. patent application Ser. No. 14/723,005, filed on May 27, 2015, which is hereby incorporated by reference in its entirety.

FIG. 7 illustrates method 700 of operating data storage environment 300 to generate a globally unique identifier. In method 700, a component of the globally unique identifier is a unique tape identifier that is read from magnetic tape cartridge 342 (701). The unique tape identifier may be read optically from the external surface of magnetic tape cartridge 342 (e.g., from a barcode, from a traditional label using optical character recognition, etc.), may be read magnetically from a designated position on the magnetic tape of magnetic tape cartridge 342, may be read using radio frequency identification (RFID), or may be read from magnetic tape cartridge 342 in some other manner. Likewise, tape libraries 304 will further be equipped with whatever hardware is necessary to read the chosen format of unique tape identifiers from magnetic tape cartridges therein (e.g., cameras, barcode readers, RFID readers, etc.).

A unique tape identifier may be assigned to each magnetic tape cartridge at the time of manufacturer, before delivery to a customer, or at some other point before a globally unique identifier is generated for data on the magnetic tape cartridge. Since each magnetic tape cartridge in tape libraries 302-304 has a tape identifier that is unique from any other magnetic tape cartridge accessible via data management system 301, any globally unique identifier generated (702) using a particular tape's identifier is guaranteed to also be unique. For instance, the element that identifies magnetic tape cartridge 342 in the example globally unique identifiers described above may be a unique tape identifier read from magnetic tape cartridge 342.

FIG. 8 illustrates method 800 of operating data storage environment 300 to access removable storage media using globally unique identifiers. In this example, sets of unique identifiers are determined for each of entities 361 and 362 (801). The unique identifiers may be full globally unique identifiers in examples where the globally unique identifiers do not explicitly include data location information or may just be components of a globally unique identifier to be generated in the future, such as the unique tape identifiers discussed above with respect to method 700.

The unique identifiers are then licensed to entities 361 and 362 (802). Entities 361 and 362 then use their respective licensed identifier sets, or data management system 301 uses the sets on their behalf, when storing their respective data sets to magnetic tape cartridges in tape libraries 302-304 (803). In some examples, data management system 301 handles the storage of data from both entities 361 and 362 while, in other examples, one or more of entities 361 and 362 may implement their own tape libraries and data management systems using the licensed unique identifiers. Data management system 301 may be configured to handle the selection of the licensed unique identifier sets or another system may be implemented to handle such functionality.

In one licensing example, each tape having tape has its own unique tape identifier, as described with respect to method 700. Those unique tape identifiers may be already assigned to magnetic tape cartridges or will be at a later time. The unique tape identifiers are sold to different entities, such as entity 361 and entity 362. The tapes in use by those entities are therefore kept separate logically based on the unique tape identifiers assigned to each entity.

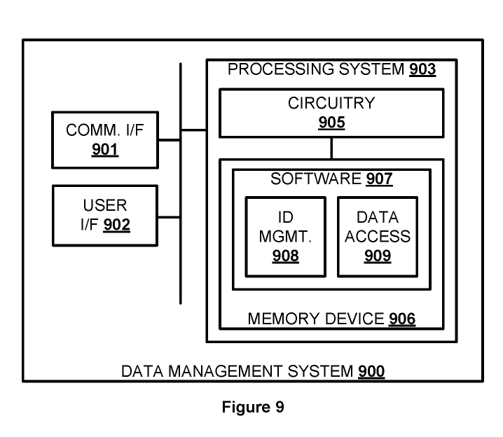

FIG. 9 illustrates data management system 900. Data management system 900 is an example of media movement control system 101, although system 101 may use alternative configurations. Data management system 900 comprises communication interface 901, user interface 902, and processing system 903. Processing system 903 is linked to communication interface 901 and user interface 902. Processing system 903 includes processing circuitry 905 and memory device 906 that stores operating software 907.

Communication interface 901 comprises components that communicate over communication links, such as network cards, ports, RF transceivers, processing circuitry and software, or some other communication devices. Communication interface 901 may be configured to communicate over metallic, wireless, or optical links. Communication interface 901 may be configured to use TDM, IP, Ethernet, optical networking, wireless protocols, communication signaling, or some other communication format—including combinations thereof.

User interface 902 comprises components that interact with a user. User interface 902 may include a keyboard, display screen, mouse, touch pad, or some other user input/output apparatus. User interface 902 may be omitted in some examples.

Processing circuitry 905 comprises microprocessor and other circuitry that retrieves and executes operating software 907 from memory device 906. Memory device 906 comprises a non-transitory storage medium, such as a disk drive, flash drive, data storage circuitry, or some other memory apparatus. Operating software 907 comprises computer programs, firmware, or some other form of machine-readable processing instructions. Operating software 907 includes global identifier management module 908 and data access module 909. Operating software 907 may further include an operating system, utilities, drivers, network interfaces, applications, or some other type of software. When executed by circuitry 905, operating software 907 directs processing system 903 to operate data management system 900 as described herein.

In particular, global identifier management module 908 directs processing system 903 to assign a first globally unique identifier to a first item of removable storage media. Data access module 909 directs processing system 903 to receive a first request to access the first item, wherein the first request includes the first globally unique identifier. In response to the first request, global identifier management module 908 directs processing system 903 to use the first globally unique identifier to determine a location of the first item from a plurality of removable storage media items. Data access module 909 directs processing system 903 to provide access to the first item.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of accessing removable data storage media using globally unique identifiers, the method comprising:
assigning a first globally unique identifier to a first item of removable storage media;
receiving a first request to access the first item, wherein the first request includes the first globally unique identifier;
in response to the first request, using the first globally unique identifier to determine a location of the first item from a plurality of removable storage media items; and
providing access to the first item.

2. The method of claim 1, further comprising:
writing first data to the first item; and
wherein assigning the first globally unique identifier first item comprises assigning the first globally unique identifier to the first data.

3. The method of claim 2, wherein the first globally unique identifier comprises information describing the location of the first item and a location of the first data on the first item.

4. The method of claim 2, wherein a lookup table indicates the location of the first item and a location of the first data on the first item in association with the first globally unique identifier, and wherein using the first globally unique identifier to locate the first item comprises:
referencing the lookup table to identify the location of the first item and the location of the first data.

5. The method of claim 2, further comprising:
receiving the first data over a communication network from a first user;
providing the first globally unique identifier to the first user over the communication network; and
wherein receiving the first request comprises receiving the first request from the first user.

6. The method of claim 5, further comprising:
associating the first globally unique identifier with the first user;
determining that the first request is associated with the first user; and
wherein providing access to the first item occurs in response to determining that the first request is associated with the first user.

7. The method of claim 5, further comprising:
designating a plurality of globally unique identifiers to an entity associated with the first user; and
wherein assigning the first globally unique identifier comprises selecting the first globally unique identifier from the plurality of globally unique identifiers.

8. The method of claim 5, further comprising:
designating a plurality of globally unique identifiers to a geographic region that includes the location of the first item; and
wherein assigning the first globally unique identifier comprises selecting the first globally unique identifier from the plurality of globally unique identifiers.

9. The method of claim 1, further comprising:
generating the first globally unique identifier based on the first item.

10. The method of claim 1, wherein assigning the first globally unique identifier comprises:
optically reading at least a component of the first globally unique identifier from a barcode on the first item.

11. The method of claim 1, wherein assigning the first globally unique identifier comprises:
reading at least a component of the first globally unique identifier from information stored on the first item.

12. The method of claim 1, wherein the first item comprises one of a magnetic tape cartridge, a solid-state memory drive in a removable enclosure, or a hard disk drive in a removable enclosure.

13. The method of claim 1, wherein the first globally unique identifier comprises a uniform resource locator (URL).

14. A system for accessing removable data storage media using globally unique identifiers, the system comprising:
one or more computer readable storage media;
a processing system operatively coupled with the one or more computer readable storage media; and
program instructions stored on the one or more computer readable storage media that, when read and executed by the processing system, direct the processing system to:
assign a first globally unique identifier to a first item of removable storage media;
receive a first request to access the first item, wherein the first request includes the first globally unique identifier;
in response to the first request, use the first globally unique identifier to determine a location of the first item from a plurality of removable storage media items; and
provide access to the first item.

15. The system of claim 14, wherein the program instructions further direct the processing system to:
write first data to the first item; and
wherein to assign the first globally unique identifier first item, the program instructions direct the processing system to at least assign the first globally unique identifier to the first data, wherein the first globally unique identifier comprises information describing the location of the first item and a location of first data on the first item.

16. The system of claim 15, wherein a lookup table indicates the location of the first item and a location of the first data on the first item in association with the first globally unique identifier, and wherein to use the first globally unique identifier to locate the first item, the program instructions direct the processing system to at least:
reference the lookup table to identify the location of the first item and the location of the first data.

17. The system of claim 15, wherein the program instructions further direct the processing system to:
receive the first data over a communication network from a first user;
provide the first globally unique identifier to the first user over the communication network; and
wherein the first request is received from the first user.

18. The system of claim 17, wherein the program instructions further direct the processing system to:
associate the first globally unique identifier with the first user;
determine that the first request is associated with the first user; and
wherein providing access to the first item occurs in response to determining that the first request is associated with the first user.

19. The system of claim 17, wherein the program instructions further direct the processing system to:
designate a plurality of globally unique identifiers to an entity associated with the first user; and
wherein assigning the first globally unique identifier comprises selecting the first globally unique identifier from the plurality of globally unique identifiers.

20. The system of claim 17, wherein the program instructions further direct the processing system to:
designate a plurality of globally unique identifiers to a geographic region that includes the location of the first item; and
wherein assigning the first globally unique identifier comprises selecting the first globally unique identifier from the plurality of globally unique identifiers.
